(19) United States
(12) Patent Application Publication
(10) Pub. No.: US 2026/0338987 A1
(43) Pub. Date: Oct. 29, 2026

(54) Sigma_b-Adaptive Gravity Kernel for Cluster Weak-Lensing

(71) Applicant: Jonathan Washburn, Austin, TX (US)

(72) Inventor: Jonathan Washburn, Austin, TX (US)

(21) Appl. No.: 19/654,929

(22) Filed: Apr. 22, 2026

Related U.S. Application Data
(60) Provisional application No. 63/794,510, filed on Apr. 25, 2025.

(51) Int. Cl. G01V 7/06; G06F 17/14; G06F 17/18

(52) U.S. Cl. CPC G01V 7/06; G06F 17/142; G06F 17/18

(57) ABSTRACT

Methods and systems are disclosed for cluster-scale gravitational modeling using a baryonic coverage factor that attenuates a fixed fractional-Poisson kernel. Projected baryonic surface-density information is obtained for one or more cluster regions, and a coverage factor is generated therefrom. The coverage factor is applied multiplicatively to a fixed fractional gravitational kernel to produce a modified kernel that is applied to density information to compute gravitational potential and weak-lensing outputs, including convergence and shear. In a disclosed implementation, the coverage factor is given by C(R)=[1+Sigma_b(R)/Sigma_star]\hat{ }(−7/12), with fixed kernel parameters and without fitting cluster-specific dark-matter halo parameters. Preferred embodiments employ radial profiles, X-ray and Sunyaev-Zel'dovich inputs, and FFT-based solver pipelines.

### CROSS-REFERENCE TO RELATED APPLICATIONS

This Non-Provisional Patent Application claims priority to U.S. Provisional Patent Application No. 63/794,510, filed Apr. 25, 2025, and titled “b-Adaptive Gravity Kernel for Cluster Weak-Lensing”.

### BACKGROUND

The present disclosure relates generally to computational astrophysics, gravitational lensing, galaxy-cluster modeling, and fractional gravitational solvers. More particularly, the disclosure concerns methods and systems for modifying a fixed fractional-Poisson gravity kernel using projected baryonic surface density in order to compute cluster-scale gravitational potential and weak-lensing outputs without fitting cluster-specific dark-matter halo parameters.

Galaxy-cluster weak-lensing analysis is commonly addressed using dark-matter halo models such as Navarro-Frenk-White, Einasto, and related profile families. In such approaches, cluster-scale lensing behavior is often represented by introducing cluster-specific halo parameters, such as concentration, virial mass, scale radius, and, in some cases, inner-slope parameters. Although such fitted halo models can provide good agreement with observational data, they do so at the cost of object-by-object parameter fitting and associated degeneracy.

The disclosure record underlying the present application further identifies a distinct problem arising when a fixed fractional gravitational kernel is applied at galaxy-cluster scale without baryonic coverage modulation. In that setting, the unmodulated kernel is described as tending to over-predict weak-lensing signal, particularly in baryon-rich cluster regions such as dense intra-cluster-medium cores. This creates a need for a cluster-scale correction that is tied to observable baryonic structure rather than to per-cluster halo fitting.

Galaxy clusters contain substantial observable baryonic content, including hot gas detectable through X-ray measurements and the Sunyaev-Zel'dovich effect, as well as stellar baryonic contributions that may be estimated from optical or related observations. These observable baryonic distributions provide a physical basis for constructing a baryonic surface-density profile that can be used to modulate a fixed gravitational kernel in a deterministic way.

Accordingly, a need exists for a cluster-scale gravitational-modeling architecture that preserves a fixed kernel identity, derives its modulation from projected baryonic surface density, reduces or avoids cluster-wise halo fitting, and remains compatible with practical transform-based computational pipelines for generating gravitational potential, convergence, shear, magnification, and related outputs.

### SUMMARY

The present disclosure provides methods and systems for cluster-scale gravitational modeling in which projected baryonic surface density is used to generate a baryonic coverage factor that attenuates a fixed fractional gravitational kernel. In the disclosed architecture, the coverage factor is applied multiplicatively to the fixed kernel to produce a modified kernel that may be used to compute gravitational potential and weak-lensing outputs without fitting cluster-specific dark-matter halo parameters.

In a disclosed core implementation, the coverage factor is computed from projected baryonic surface density as a function of cluster-centric radius and is combined with a fixed fractional-Poisson kernel having fixed kernel parameters. The resulting modified kernel may be applied in a transform-based solver to generate gravitational potential, convergence, shear, magnification, mass-estimation, and related outputs. The architecture preserves a fixed mathematical identity across clusters and avoids object-by-object halo re-tuning.

Preferred embodiments include radial-profile implementations in which projected baryonic surface density is derived from X-ray observations, Sunyaev-Zel'dovich observations, combined X-ray/SZ observations, or other baryonic data products and is stored or represented in a radial structure for repeated use during solver execution. In such embodiments, the coverage factor may be stored in a lookup structure and applied within an FFT-based solving pipeline.

Optional and alternative embodiments may include non-radial coverage configurations, redshift-dependent coverage configurations, and multi-component attenuation configurations. These embodiments may be useful for preserving flexibility and future claim support, but do not alter the identity of the core invention as the Sigma_b-driven multiplicative attenuation of a fixed fractional gravitational kernel for cluster-scale modeling without per-cluster halo fitting.

### BRIEF DESCRIPTION OF THE DRAWINGS

FIG. 1 illustrates an overall architecture of a system for generating projected baryonic surface-density information, computing a baryonic coverage factor, combining that coverage factor with a fixed fractional kernel, solving for gravitational potential, and generating lensing-related outputs.

FIG. 2 illustrates a representative method flow for receiving baryonic input information, deriving projected baryonic surface density, computing a coverage factor, forming a modified kernel, solving for gravitational potential, and deriving one or more weak-lensing outputs.

FIG. 3 illustrates core mathematical relationships associated with the disclosed method, including the coverage-factor relation, the fixed base fractional kernel, the modified kernel, and representative limiting behaviors of the disclosed attenuation architecture.

FIG. 4 illustrates representative pathways by which projected baryonic surface density may be derived from X-ray data, Sunyaev-Zel'dovich data, combined observational inputs, optical stellar-mass information, simulation-derived inputs, or combinations thereof.

FIG. 5 illustrates a preferred radial coverage-table embodiment in which projected baryonic surface density values and corresponding coverage-factor values are represented in a radial structure suitable for repeated use during solver execution.

FIG. 6 illustrates a modified solving pipeline in which a baryonic coverage factor is applied to a fixed fractional kernel during transform-based computation of gravitational potential.

FIG. 7 illustrates generation of primary and secondary outputs from the modified solver, including gravitational potential, convergence, shear, magnification, and derived mass-related outputs.

FIG. 8 illustrates a validation framework for organizing benchmark cluster comparisons, worked examples, and implementation-performance metrics associated with the disclosed Sigma_b-adaptive kernel architecture.

FIG. 9 illustrates optional and alternative embodiments including non-radial coverage configurations, redshift-dependent coverage configurations, and multi-component attenuation configurations.

FIG. 10 illustrates optional deployment implementations for executing the disclosed method in accelerator-based, batch-processing, or service-oriented computational environments.

### DETAILED DESCRIPTION

The present disclosure relates to cluster-scale gravitational modeling and, more particularly, to methods and systems that attenuate a fixed fractional-Poisson gravity kernel using projected baryonic surface density so as to generate gravitational potential and weak-lensing outputs without fitting per-cluster dark-matter halo parameters. The invention does not concern dark-matter-free gravity in general, all baryon-based lensing models, or all density-dependent kernel modulation schemes. Rather, the invention concerns a specific kernel architecture in which a disclosed baryonic coverage factor is applied multiplicatively to a fixed base fractional kernel.

In the disclosed core implementation, the method computes a coverage factor C(R) from projected baryonic surface density Sigma_b(R), applies that coverage factor multiplicatively to a fixed base kernel K0(k), and uses the resulting modified kernel K(k,R) to compute cluster gravitational potential and/or weak-lensing observables. The disclosed approach preserves a fixed mathematical identity across clusters and does not introduce per-cluster halo-fitting parameters of the type commonly associated with NFW, Einasto, or related dark-matter halo models.

The broader Recognition framework may be referenced as a framework anchor for fixed-parameter posture, anti-per-object-tuning logic, and related interpretive structure. However, the specific Sigma_b-adaptive cluster-lensing architecture disclosed herein should be treated as grounded in the present cluster-lensing disclosure and any cited cluster-lensing formalization record. Accordingly, this Detailed Description distinguishes between: (i) core disclosed mathematics and method steps; (ii) preferred but non-mandatory implementation details; (iii) optional and alternative embodiments; (iv) demonstrated examples; and (v) prophetic, downstream, or future-facing extensions.

The core invention disclosed herein is the Sigma_b-driven multiplicative attenuation of a fixed fractional gravitational kernel for cluster-scale modeling without per-cluster halo fitting. Preferred embodiments include the disclosed radial implementation, preferred input pipelines, and preferred solver pathways. Optional and alternative embodiments include non-radial, redshift-dependent, multi-component, and other implementation variants that do not redefine the inventive center. Demonstrated examples are presented as validation-oriented illustrations supported by the disclosure record. Prophetic examples, downstream applications, and continuation-oriented targets are included to preserve support and future flexibility, but they remain subordinate to the disclosed core invention and should not be read as replacing or expanding the identity of that core invention.

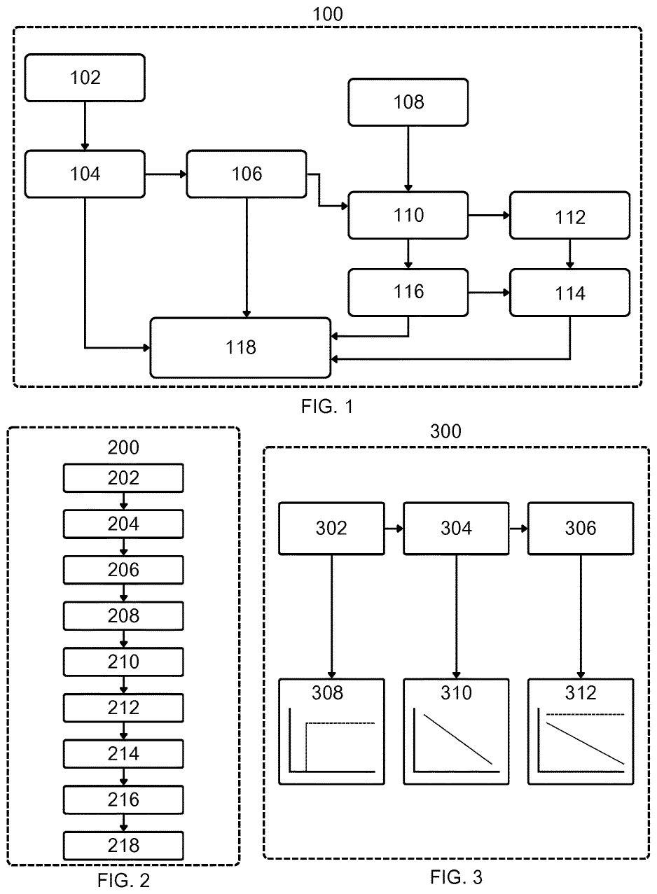

As illustrated in FIG. 1, a representative system (100) may include a baryonic input source (102), a profile-generation module (104), a coverage-factor engine (106), a base-kernel engine (108), a kernel-combination engine (110), a solver engine (112), an output engine (114), a validation engine (116), and a metadata/provenance module (118). FIG. 1 provides a high-level architectural view of how baryonic input information is converted into projected baryonic surface-density information, then into a coverage factor, then into a modified kernel that is used to generate gravitational and lensing-related outputs.

As used herein, “projected baryonic surface density” means a line-of-sight integrated, deprojected-and-reprojected, or otherwise derived projected distribution of baryonic matter associated with one or more regions of a galaxy cluster. In preferred implementations, projected baryonic surface density is expressed as Sigma_b(R), where R denotes cluster-centric radius. The baryonic matter may include hot gas, stellar baryonic content, plasma-associated baryonic mass, or combinations thereof, depending on the input data source employed.

As used herein, “coverage factor” means a baryon-dependent attenuation factor applied multiplicatively to a base gravitational kernel. In the disclosed core implementation, the coverage factor is a decreasing function of projected baryonic surface density and is constructed so that it does not amplify the base kernel.

As used herein, “attenuation-only” means that the coverage factor is bounded above by unity and therefore does not increase the magnitude of the base kernel. In the disclosed core implementation, attenuation-only behavior means that the modified kernel remains less than or equal to the base kernel for the same wavevector-space location or other corresponding computational location.

As used herein, “fixed” means not refit on a cluster-by-cluster basis within the disclosed core implementation. Thus, where the present disclosure states that an exponent, normalization, or kernel parameter is fixed, that statement means that the parameter is part of the disclosed kernel architecture and is not treated as a free fitting knob for each object being modeled.

As used herein, “no per-cluster halo fitting” means the absence of fitting dark-matter halo profile parameters for the individual cluster being modeled. This includes, by way of example, omission of per-cluster tuning of concentration, virial mass, scale radius, inner slope, or analogous halo-shape parameters.

As used herein, “radial embodiment” means a primary disclosed implementation in which Sigma_b and the resulting coverage factor are represented as functions of cluster-centric radius R. A radial embodiment may be implemented as a one-dimensional profile, a binned radial array, a radial lookup structure, or an equivalent radial representation.

As used herein, “alternative embodiment” means a disclosed implementation branch that is not required for practice of the core invention. Similarly, “demonstrated example” means an example presented as supported by the disclosure record, while “prophetic example” means an example or forward-looking extension presented to preserve support without representing that the embodiment has been reduced to practice to the same extent as the core or demonstrated implementations.

The disclosed invention operates on a fixed base fractional-Poisson gravitational kernel. In the disclosed core implementation, the base kernel is:

K0(k)=1/(|k|\hat{ }2+k0\hat{ }2)\hat{ }(5/12)

where k denotes a Fourier-space wavevector and k0 denotes a softening term. In the disclosed core implementation, the softening term is:

k0=pi/phi

where phi denotes the golden ratio. The order 5/12 and the softening k0=pi/phi are treated as fixed kernel parameters in the disclosed core implementation and are not refit per cluster.

The disclosed core implementation further defines a baryonic coverage factor C(R) according to:

C(R)=[1+Sigma_b(R)/Sigma_star]\hat{ }(−7/12)

where Sigma_b(R) is projected baryonic surface density and Sigma_star is a fixed adopted reference scale. In the disclosed core implementation:

Sigma_star=90g/cm\hat{ }2

Sigma_star is not refit on an object-by-object basis. Rather, it serves as a fixed normalization scale within the disclosed kernel architecture. The exponent −7/12 is likewise fixed in the disclosed core implementation. In the cluster-lensing disclosure record, the exponent −7/12 is further presented as the negative of the Recognition-Physics loop ratio R_RP.

Operationally, the disclosed coverage factor decreases as projected baryonic surface density increases. Accordingly, a region having relatively high projected baryonic density yields a smaller coverage factor than a region having relatively low projected baryonic density.

The disclosed modified kernel is formed multiplicatively as:

K(k,R)=C(R)*K0(k)

This multiplicative structure is important. The invention does not merely add an empirical correction term to the base kernel, nor does it replace the base kernel with an unrelated profile family. Instead, the base fractional kernel is preserved and attenuated by a baryonic coverage factor computed from projected baryonic surface density.

Because the coverage factor is attenuation-only in the disclosed core implementation, the modified kernel does not amplify the base kernel. In the disclosed core implementation, the modified kernel remains positive for nonnegative Sigma_b and remains less than or equal to the base kernel at corresponding computational locations. In preferred computational implementations, the modified kernel is convolved with a mass-density grid to obtain a gravitational potential output, a lensing-shear map, or both.

The disclosed coverage law admits several useful limiting cases. When Sigma_b=0, the coverage factor reduces to unity:

C(R)=[1+0/Sigma_star]\hat{ }(−7/12)=1

Accordingly, the vacuum limit recovers the base kernel. This is an important property of the disclosed architecture because it shows that the baryonic modulation does not alter the base kernel when projected baryonic surface density is absent.

When Sigma_b=Sigma_star, the coverage factor becomes:

C(R)=2\hat{ }(−7/12)

which corresponds to moderate attenuation. When Sigma_b is substantially greater than Sigma_star, the coverage factor decreases further and yields stronger attenuation. In the formal limit Sigma_b−>infinity, the disclosed coverage factor approaches zero.

The disclosed core implementation is structured so that increasing projected baryonic surface density corresponds to decreasing coverage factor. Thus, if Sigma_b1<Sigma_b2, then C(Sigma_b2)<C(Sigma_b1), subject to the same disclosed coverage law. This monotonicity is strategically important because it ties the attenuation directly to observable baryonic loading rather than to arbitrary cluster-specific fitting adjustments.

In the disclosed core implementation, the following mathematical properties are treated as part of the load-bearing kernel structure:
(a) C(R)>0 for nonnegative Sigma_b;
(b) C(R)<=1;
(c) C(R)=1 when Sigma_b=0;
(d) C(R) decreases as Sigma_b increases;
(e) K(k,R)>0 when K0(k)>0 and Sigma_b is nonnegative; and
(f) K(k R)<=K0(k).

Where formal verification is referenced later in this specification, it should be understood as support for these mathematical properties of the disclosed coverage-factor structure. Such references should not be read to imply that every empirical consequence or full-stack cluster-lensing prediction is formally closed by the broader Recognition framework source unless expressly stated.

As illustrated in FIG. 3, a mathematical framework (300) may include a coverage equation block (302), a base-kernel block (304), and a modified-kernel block (306). FIG. 3 may further include a vacuum-limit illustration (308), a monotonic attenuation illustration (310), and a boundedness illustration (312), each of which visually reinforces the disclosed properties that the coverage factor remains positive, does not exceed unity, decreases with increasing projected baryonic surface density, and recovers the base kernel in the vacuum limit.

The disclosed invention addresses a cluster-scale mismatch that arises when the underlying base fractional kernel is applied without baryonic coverage modulation. As presented in the disclosure record, use of the unmodulated kernel at galaxy-cluster scales tends to over-predict weak-lensing signal, particularly in baryon-rich regions such as dense cluster cores.

The disclosed solution is to attenuate the base kernel in a manner tied to projected baryonic surface density. Because dense regions of the intra-cluster medium correspond to larger Sigma_b values, those regions produce smaller coverage factors under the disclosed coverage law. The resulting attenuation reduces the effective kernel strength where the over-response is greatest. By contrast, in low-density outskirts or field-like regions where Sigma_b approaches zero, the coverage factor approaches unity and the base kernel is recovered.

This yields an operational profile in which the cluster core is more strongly attenuated than the outskirts. In consequence, the modified kernel can reduce core over-response while preserving the behavior of the fixed base kernel in lower-density regions. The resulting potential and lensing outputs therefore differ from those obtained using the unmodulated kernel, with the most substantial change occurring where projected baryonic loading is greatest.

The disclosed architecture is strategically fixed rather than cluster-wise re-tuned. In the disclosed core implementation, the coverage exponent (−7/12), the base-kernel order (5/12), the softening (k0=pi/phi), and the reference scale (Sigma_star=90 g/cm\hat{ }2) are fixed as part of the kernel architecture and are not re-fit for each cluster. As a result, the architecture is falsifiable in the sense that, if the fixed coverage law fails on a new cluster, the framework is challenged rather than rescued by introducing cluster-wise halo knobs.

The present disclosure may describe this effect using Recognition-framed language such as recognition density, recognition coverage, or baryonic coverage modulation of coupling. Such language is intended to describe the disclosed architecture and its physical interpretation as presented in the disclosure record. Practice of the computational method itself does not require that every broader Recognition proposition be accepted as an independent claim limitation.

The disclosed method may operate on several classes of input. In preferred implementations, the method receives or derives projected baryonic surface-density information for one or more cluster regions. Additional inputs may include cluster geometry information, mass-density-grid information, numerical solver configuration information, output-resolution settings, and implementation-specific computational parameters.

Projected baryonic surface density may be obtained directly as a prepared radial profile or may be derived from one or more source datasets. In the radial embodiment, the prepared quantity is Sigma_b(R), expressed as a function of cluster-centric radius R. In representative embodiments, Sigma_b(R) may be derived from X-ray observations, Sunyaev-Zel'dovich observations, stellar-mass observations, or combinations thereof.

In one preferred implementation, Sigma_b(R) is derived from X-ray observations of the intra-cluster medium. A representative pipeline includes:
(a) acquiring X-ray surface-brightness data S_X(R);
(b) converting the X-ray data into a gas-density proxy;
(c) deprojecting the proxy to estimate three-dimensional gas density rho_gas(r);
(d) projecting the gas density along the line of sight to obtain projected baryonic surface density Sigma_b(R); and
(e) converting the resulting profile into a computationally usable radial representation.

In implementations based on the disclosure record, the line-of-sight relation may be expressed as:

Sigma_b(R)=integral rho_gas(r)dl

with additional observational conversions performed as appropriate for the particular instrument pipeline used. In one representative X-ray relation, the surface-brightness observable satisfies:

S_X(R)∝n_e\hat{ }2Λ(T) Integral dl

so that the observed X-ray surface brightness may be used to infer gas density, deproject to obtain rho_gas(r), and then project back to obtain Sigma_b(R).

In another preferred implementation, Sigma_b(R) is derived from Sunyaev-Zel'dovich data. A representative pipeline includes:
(a) acquiring Compton-y measurements for one or more cluster regions;
(b) converting the measurements into a baryonic surface-density proxy;
(c) normalizing, scaling, or otherwise preparing the resulting values for use in the disclosed coverage law; and
(d) binning or otherwise representing the resulting profile as Sigma_b(R).

The disclosure record also contemplates use of standard Compton-y-based conversion relationships to obtain a baryonic surface-density representation suitable for input into the coverage-factor computation. In one representative implementation, the Compton-y profile may be expressed as:

y(R)=(sigma_T/m_ec\hat{ }2) integral n_ek_BT_edl

and may be converted into baryonic surface density according to:

Sigma_b=(mum_p/sigma_T)*(m_ec\hat{ }2/k_BT_e)*y(R)

Where both X-ray and SZ data are available, a combined-input implementation may be used. In one such implementation:
(a) X-ray-derived and SZ-derived datasets are registered to a common cluster-centric coordinate system;
(b) spatial and radial coordinates are harmonized;
(c) overlapping radial regions are reconciled to produce a prepared radial profile; and
(d) the resulting merged profile is used as Sigma_b(R).

If both X-ray and SZ source products are available, a combined prepared profile may be treated as preferred. Such a combined profile may preserve both spatial and thermal information about the intra-cluster medium. If only one modality is available, the available modality may be used directly. If multiple source products must be reconciled, the reconciliation should be described as an implementation detail for preparing the radial profile rather than as part of the inventive core itself.

In optional embodiments, projected baryonic surface density may be derived in whole or in part from optical stellar-mass maps, hydrodynamic simulation outputs, or other baryonic data products. Such pathways are preserved as optional or alternative support and do not redefine the core identity of the invention, which remains the Sigma_b-driven multiplicative attenuation of the fixed base kernel. Representative prepared baryonic-density profiles may be accepted in FITS, HDF5, CSV, or other suitable machine-readable formats.

Prepared input data may undergo one or more preprocessing operations, including radial averaging, interpolation, normalization, smoothing, denoising, clipping, or related preparation steps. Such operations are implementation details rather than load-bearing aspects of the inventive concept.

In preferred implementations, the prepared radial profile satisfies the following conditions before use in the disclosed coverage law:
(a) the prepared Sigma_b profile is physically nonnegative;
(b) the radial coordinate assignment is internally consistent;
(c) the radial range covers the region of interest for the solver; and
(d) the resolution is sufficient for subsequent coverage lookup or equivalent kernel-modulation operations.

If data quality is insufficient in one or more regions, interpolation or extrapolation may be used as optional preprocessing. Such preprocessing should remain subordinate to the core kernel architecture.

As illustrated in FIG. 4, an input pipeline framework (400) may include an X-ray branch (402), an SZ branch (404), a combined-input branch (406), an optical branch (408), and a simulation branch (410), each of which may provide information to a radial-profile output (412). FIG. 4 is useful for showing that X-ray and SZ pathways are preferred data-source implementations, while optical and simulation-derived pathways are preserved as additional or optional input embodiments.

In a representative implementation, the disclosed method includes the following stages:
Stage 1: receive or derive Sigma_b(R);
Stage 2: compute C(R) from Sigma_b(R);
Stage 3: generate or retrieve the fixed base kernel K0(k);
Stage 4: form the modified kernel K(k,R)=C(R)*K0(k);
Stage 5: convolve or otherwise apply the modified kernel to a mass-density grid or other density information;
Stage 6: compute gravitational potential Phi;
Stage 7: derive one or more lensing outputs, including a lensing-shear map where desired, from Phi; and
Stage 8: generate derived outputs such as mass estimation, magnification, reporting, or validation data where desired.

After a prepared Sigma_b(R) profile is available, the method computes C(R) according to the disclosed fixed-form coverage law. In the disclosed core implementation, this includes:
(a) evaluating the ratio Sigma_b(R)/Sigma_star;
(b) adding unity to that ratio;
(c) applying the fixed exponent −7/12; and
(d) storing or otherwise representing the resulting C(R) values for subsequent kernel application.

In implementations using a radial lookup structure, the resulting coverage values may be stored in a radial table, texture, cache-resident structure, or other suitable memory representation.

The method then forms the modified kernel by multiplying the coverage factor with the base kernel:

K(k,R)=C(r)*K0(k)

This multiplication may be performed on the fly, through lookup-assisted evaluation, or through a precomputed or partially precomputed representation, provided that the disclosed multiplicative attenuation architecture is preserved.

In a preferred radial FFT implementation, the coverage lookup may be indexed through a radius-wavevector relation of the form:

R=2pi/|k|

This relation is a preferred implementation detail for the disclosed radial solver path and may support narrower dependent claim positions.

Once the modified kernel has been formed, the method applies the modified kernel to the relevant density information to compute gravitational potential. In one preferred spectral implementation, density information is transformed into Fourier space, multiplied by the modified kernel, and transformed back to yield the potential field Phi(r). The disclosed workflow preserves the base fractional kernel structure while modulating it using the baryonic coverage factor. In a preferred implementation, the modified kernel is convolved with a mass-density grid to obtain the gravitational potential Phi(r) and, where desired, one or more lensing-shear outputs derived therefrom.

In one representative Fourier-domain implementation, a transformed density field rho_tilde(k) is multiplied by the modified kernel K(k,R) to obtain a transformed potential field Phi_tilde(k), after which an inverse transform is performed to recover Phi(r). The disclosed spectral pipeline may therefore be summarized as:

Phi_tilde(k)=−4piGK(k,R)rho_tilde(k)

followed by inverse transform to obtain Phi(r), and optional spectral derivative operations to obtain convergence and shear.

In implementations directed to weak-lensing observables, the method derives convergence and shear from the computed potential. In a preferred spectral embodiment, the disclosure preserves the following fallback relations:

kappa(theta)=½nabla\hat{ }2_perp Phi

gamma1=½(d\hat{ }2Phi/dx\hat{ }2−d\hat{ }2Phi/dy\hat{ }2)

gamma2=d\hat{ }2Phi/dxdy

These relations may be implemented spectrally and, in preferred embodiments, via spectral second derivatives of the solved potential without requiring additional transforms beyond those already used in the disclosed solving pipeline, depending on the implementation selected.

The disclosed workflow may branch after potential generation or after lensing-output generation. Optional branches include:
(a) a potential-only branch;
(b) a full weak-lensing branch;
(c) a magnification branch;
(d) a mass-estimation branch; and
(e) a batch-processing branch for multiple clusters or datasets.

Representative outputs therefore include gravitational potential, convergence maps, shear maps, magnification values, integrated or projected mass estimates, residual-comparison data, and related reporting or provenance information. These outputs and downstream uses should remain subordinate to the disclosed kernel architecture and should not replace the identity of the invention.

In preferred implementations, the method may validate the prepared coverage factor and resulting modified kernel prior to or during use. Representative validation checks include:
(a) C(R)>0;
(b) C(R)<=1;
(c) monotone downward coverage behavior as a function of increasing Sigma_b for the prepared profile;
(d) positivity of the modified kernel where the base kernel is positive; and
(e) K(k,R)<=K0(k).

Additional implementation-level checks may include interpolation consistency, bounded numerical error, precision-path comparison, and runtime or memory benchmarks. Such checks support make-and-use disclosure and demonstrated implementation quality, but should not be imported into the broadest independent claim unless expressly desired.

The foregoing Detailed Description sections describe the top of the disclosed method and establish the core make-and-use pathway for the Sigma_b-adaptive kernel architecture. Subsequent sections may address system modules, solver embodiments, formal verification anchors, outputs, optional embodiments, examples, and downstream applications while maintaining the same core identity.

As illustrated in FIG. 2, a representative method flow (200) may include a receive input step (202), a derive projected baryonic surface density step (204), a compute coverage factor step (206), a retrieve base kernel step (208), a form modified kernel step (210), a solve potential step (212), a derive lensing outputs step (214), a generate derived products step (216), and a validation step (218). FIG. 2 therefore provides a figure-linked view of the overall make-and-use method already described in this specification.

The disclosed invention may be embodied in a computational system configured to receive baryonic input information, compute a baryonic coverage factor, combine that coverage factor with a fixed base fractional kernel, solve for gravitational potential, and derive lensing or related outputs. Although the invention can be implemented in a variety of computational environments, the core inventive identity remains the Sigma_b-driven multiplicative attenuation of the fixed fractional kernel, not the particular hardware or software packaging selected to execute that architecture.

In one representative system arrangement, the disclosed system includes a baryonic input source, a profile-generation module, a coverage-factor engine, a base-kernel engine, a kernel-combination engine, a solver engine, an output engine, and a validation engine. An optional metadata/provenance module may also be provided. These components may be implemented as software, firmware, hardware logic, or combinations thereof. In spectral implementations, the kernel-combination engine may apply the coverage factor to the base kernel at Fourier-space grid points used by the solver engine.

The baryonic input source receives or provides baryonic input information suitable for generation of projected baryonic surface density. In preferred implementations, the baryonic input source is configured to accept X-ray data, Sunyaev-Zel'dovich data, combined X-ray/SZ products, prepared radial profiles, optical stellar-mass inputs, simulation-derived baryonic profiles, or combinations thereof. The baryonic input source may also receive cluster geometry information, numerical grid definitions, coordinate mappings, and solver configuration data.

The profile-generation module receives the baryonic input information and derives or prepares projected baryonic surface-density information therefrom. Where necessary, the profile-generation module may perform or invoke preprocessing operations such as coordinate registration, unit normalization, radial averaging, rebinning, or other preparation steps. Such preprocessing supports implementation of the disclosed method but does not redefine the inventive core.

The coverage-factor engine computes the baryonic coverage factor from the prepared projected baryonic surface-density information. In the disclosed core implementation, the coverage-factor engine evaluates:

C(R)=[1+Sigma_b(R)/Sigma_star]\hat{ }(−7/12)

using the fixed exponent −7/12 and the fixed adopted reference scale Sigma_star=90 g/cm\hat{ }2.

The coverage-factor engine may store or access the fixed constants of the disclosed core implementation and may produce a radial array, lookup table, texture, or equivalent representation of the resulting coverage values for subsequent use by the kernel-combination engine and solver engine.

The base-kernel engine stores, generates, or otherwise accesses the fixed base fractional kernel used by the disclosed method. In the disclosed core implementation, the base-kernel engine uses:

K0(k)=1/(|k|\hat{ }2+k0\hat{ }2)\hat{ }(5/12)

with:

k0=pi/phi

The base-kernel engine may provide a direct evaluative form, a table-based form, a cached form, or another computational representation, provided that the fixed kernel architecture of the disclosed core implementation is preserved.

The kernel-combination engine forms the modified kernel by combining the coverage factor with the base fractional kernel. In the disclosed core implementation, the combination is multiplicative:

K(k,R)=C(r)*K0(k)

The kernel-combination engine may perform this multiplication on demand, through a lookup-driven path, or through a partially precomputed execution path. The engine does not introduce a new fitted halo layer. Instead, it preserves the fixed base kernel and attenuates that kernel according to the prepared baryonic coverage factor.

The solver engine applies the modified kernel to density information in order to compute gravitational potential and, where desired, lensing quantities derived from the potential. In preferred embodiments, the solver engine operates in a Fourier or spectral domain and applies the modified kernel to transformed density information before reconstructing the potential field.

In one preferred implementation, the solver engine is configured to:
(a) receive a density grid or equivalent density representation;
(b) transform the density information into Fourier space or another computational domain suitable for kernel application;
(c) apply the modified kernel K(k,R);
(d) compute the transformed potential; and
(e) reconstruct gravitational potential Phi(r) in real space or an output space suitable for downstream derivation.

The output engine generates one or more outputs from the solved potential and, where applicable, derived lensing quantities. The output engine may produce gravitational potential, convergence, shear, magnification, integrated or projected mass estimates, residual-comparison information, and other derived reporting outputs. These outputs may be stored, displayed, transmitted, or supplied to downstream computational stages. In preferred implementations, the output engine computes kappa, gamma1, and gamma2 spectrally from the modified potential.

The validation engine may evaluate one or more mathematical, numerical, or implementation-level criteria associated with the disclosed kernel architecture. In representative implementations, the validation engine checks positivity of the coverage factor, boundedness of the coverage factor, vacuum recovery, attenuation of the modified kernel relative to the base kernel, interpolation quality, bounded numerical error, or consistency across precision paths.

Validation logic supports implementation quality and demonstrated performance, but such logic should not be confused with a requirement that every validation measure become part of the broadest claim set.

An optional metadata/provenance module may record source type, constants used, radial bin structure, processing branch selected, validation status, output metadata, or similar information useful for reproducibility, audit, or downstream reporting. This module is optional and does not define the core invention.

As further illustrated in FIG. 10, a deployment framework (1000) may support execution through a GPU implementation (1002), an FPGA implementation (1004), a CPU/batch implementation (1006), a remote-service implementation (1008), and a storage and interface layer (1010). FIG. 10 is included to show secondary execution environments for the disclosed method and should not be understood as redefining the invention in deployment-centric terms.

In a preferred radial embodiment, projected baryonic surface density is represented as a radial profile and the resulting coverage factor is stored as a corresponding radial structure. The radial structure may comprise bins, sampled radial positions, interpolated knot points, or another compact representation suitable for repeated use during solver execution.

In one disclosed preferred implementation, the radial structure comprises 512 radial bins. This 512-bin embodiment is a preferred implementation detail and may support narrower fallback claim positions, but it is not required in every implementation of the inventive concept.

The radial structure may store Sigma_b values, C(R) values, or both. Interpolation may be used between bins where appropriate. The interpolation scheme may be selected to preserve the attenuation-only nature of the disclosed architecture and to avoid artifacts that would undermine positivity or monotonicity. In one preferred solver configuration, the one-dimensional radial lookup table comprises 512 bins, is accessed as a texture lookup inside an FFT-based solver, and contributes less than approximately 3% added runtime overhead relative to a corresponding base solver lacking the baryonic coverage factor.

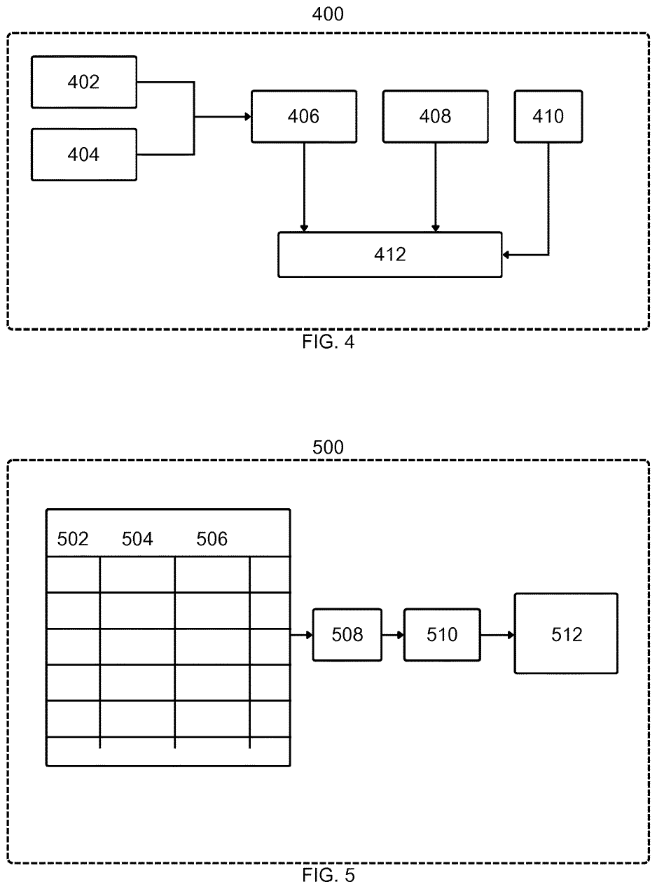

As illustrated in FIG. 5, a table architecture (500) may include radial bins (502), Sigma_b values (504), coverage-factor values (506), interpolation logic (508), a lookup interface (510), and a memory store (512). FIG. 5 is particularly useful for showing a preferred compact radial implementation in which baryonic profile information and resulting coverage-factor values are stored in a form suitable for repeated use during solver execution.

In a preferred radial FFT implementation, the solver uses a radius-wavevector relation to associate a radial coverage value with a Fourier-space location. In one disclosed implementation:

R=2pi/|k|

This relation may be used to index or otherwise select a coverage-factor value corresponding to a given wavevector magnitude. The selected value may then be multiplied with the base kernel value for that location to form the modified kernel used by the solver path.

The radial FFT path is a preferred implementation because it permits efficient reuse of a one-dimensional coverage structure while preserving the disclosed multiplicative attenuation architecture.

In preferred embodiments, density information is transformed into Fourier space, multiplied by the modified kernel, and then transformed back to obtain gravitational potential. The coverage lookup may be performed before or during kernel multiplication, provided that the modified kernel remains:

K(k,R)=C(R)*K0(k)

The disclosed implementation therefore adds the baryonic attenuation factor to the base spectral solving flow without replacing the underlying fixed kernel identity.

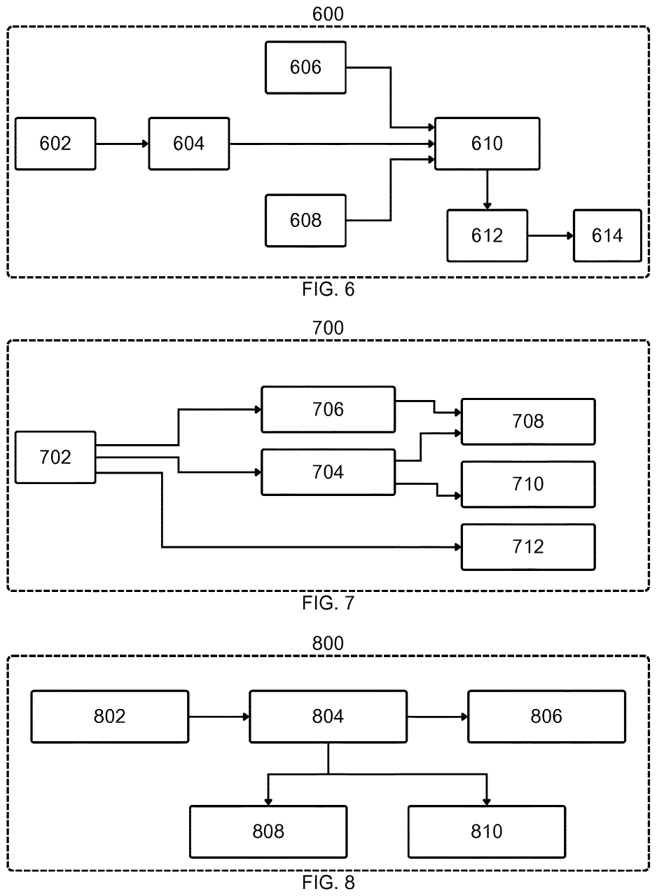

As illustrated in FIG. 6, a solver pipeline (600) may include a density-grid input (602), a Fourier transform stage (604), a base-kernel stage (606), a coverage lookup stage (608), a kernel multiply stage (610), a potential computation stage (612), and an inverse transform stage (614). FIG. 6 therefore ties the disclosed FFT-based solving path directly to the modified-kernel architecture described herein.

Where weak-lensing outputs are desired, the disclosed method may derive convergence and shear from the solved potential using spectral operations. In one preserved fallback formulation:

kappa(theta)=½nabla\hat{ }2_perp Phi

gamma1=½(d\hat{ }2Phi/dx\hat{ }2−d\hat{ }2Phi/dy\hat{ }2)

gamma2=d\hat{ }2Phi/dxdy

These relations may be implemented through corresponding spectral derivative operations. In preferred embodiments, the disclosed lensing-output path may be executed without additional transform burdens beyond those already used to compute or process the potential, depending on implementation choices.

The disclosed method may be implemented on GPU systems, FPGA systems, or other processor configurations capable of executing the described kernel-combination and solving operations. GPU and FPGA implementations are explicitly preserved as preferred engineering embodiments because they align well with repeated kernel evaluation, lookup operations, and transform-based computation. In one preferred GPU implementation, the coverage table is stored as a one-dimensional texture. In one preferred FPGA implementation, the coverage table is stored in BRAM alongside a base-kernel memory structure. Additional processor implementations may be employed as optional execution environments, but the invention should not be redefined in terms of generic deployment flexibility.

Coverage factors, base-kernel values, or related data structures may be stored in lookup tables, texture memory, ROM, BRAM, cache-resident structures, or analogous memory resources. The disclosed architecture is compatible with compact radial-table implementations and may preserve a narrow implementation position in which the added storage footprint is small relative to the rest of the solving system.

FP32 may be used as a preferred main computational path. FP64 may be used as a reference or verification path. Mixed-precision execution may also be used as an optional implementation branch. Precision-path selection is an engineering choice that supports practical deployment and validation, but it is not part of the load-bearing inventive identity.

Alternative numerical implementations may be used so long as they preserve the disclosed multiplicative attenuation architecture and do not convert the invention into an unrelated kernel-modification approach. Thus, alternative execution paths may be used for evaluation, interpolation, storage, or solver sequencing, but the base kernel, the baryonic coverage factor, and their multiplicative combination remain central.

The present disclosure preserves a set of formal property anchors associated with the disclosed coverage-factor structure. These include:
(a) coverage positivity;
(b) coverage boundedness;
(c) coverage monotonicity;
(d) vacuum recovery;
(e) exponent identity;
(f) modified-kernel positivity; and
(g) attenuation of the modified kernel relative to the base kernel.

These properties support the determinative nature of the disclosed coverage law and provide support for fallback claim positions directed to positivity, boundedness, monotonicity, vacuum recovery, and related mathematical features. In the disclosure record, these properties are associated with a cluster-lensing formalization identified as RecognitionClusterLensing.lean.

That formalization is described as proving, at minimum, the following theorem-level properties: coverage_positive, coverage_bounded, coverage_monotone, vacuum_limit, exponent_from_rrp, modified_kernel_pos, modified_le_base, and parameter_free. The disclosure record further identifies overhead_small and lensing_accuracy as formalized support for a narrow implementation and performance posture.

References to formal verification should be used carefully. Formal support may be invoked to support the mathematical properties of the disclosed coverage-factor structure. However, formal verification should not be described as proving every empirical prediction, every benchmark result, or the entire cluster-lensing stack unless such closure is expressly established in the cited formal record.

The broader Recognition framework supports the fixed-parameter and anti-object-tuning posture used by the present disclosure. At the same time, the cluster-lensing-specific extension described herein should be attributed to the cluster-lensing disclosure record and any cited cluster-lensing formalization, rather than being described as independently re-derived in every respect by the broader Recognition framework source.

It is useful to distinguish among three attribution categories.

First, certain features may be described as RS-anchored. These include the broader fixed-parameter posture, the anti-per-object-tuning posture, and the interpretive use of Recognition framework concepts as background support for a non-fit-based modeling architecture.

Second, cluster-lensing-specific mathematics may be described as RS-framed and supported in the cluster-lensing disclosure. This includes the specific Sigma_b-adaptive kernel architecture, the particular coverage law, and the associated cluster-lensing formal-property statements, unless and until those features are independently re-derived in the broader Recognition framework source.

Third, engineering implementations, measurement pipelines, and downstream uses should generally be treated as implementation embodiments or application embodiments rather than RS derivations. Thus, X-ray pipelines, SZ pipelines, FFT implementations, LUT structures, GPUs, FPGAs, cloud services, navigation adaptations, and similar details should not be described as RS-derived merely because they are compatible with the disclosed method.

If the specification references the broader Recognition framework as a credibility anchor, the disclosure should avoid implying that the entire cluster-lensing stack is formally closed in the broader framework source unless that is expressly shown. Accordingly, formal property statements such as positivity, boundedness, monotonicity, vacuum recovery, and modified-kernel attenuation should be attributed to the cluster-lensing formalization or disclosure record. This avoids overstating broader formal closure while preserving the strategic value of the formal-property structure.

The present disclosure preserves the following exact constants and orderings in the disclosed core implementation:
exponent −7/12
base-kernel order 5/12
k0=pi/phi
Sigma_star=90 g/cm\hat{ }2

For attribution purposes, the exponent may be described as fixed in the disclosed core implementation and RS-framed through the cluster-lensing source's linkage to R_RP. The base-kernel order and softening may be described as fixed kernel constants of the disclosed core implementation. Sigma_star=90 g/cm\hat{ }2 should be described as a fixed adopted reference scale in the disclosed core implementation unless additional support is supplied establishing it as independently RS-derived.

The foregoing formal and fixed-constant material also supports narrower fallback positions including:
(a) claims directed to the exact coverage formula;
(b) claims directed to the fixed exponent;
(c) claims directed to Sigma_star=90 g/cm\hat{ }2;
(d) claims directed to boundedness, monotonicity, positivity, and vacuum recovery;
(e) claims directed to the radial FFT lookup relation R=2pi/|k|;
(f) claims directed to spectral derivation of kappa, gamma1, and gamma2; and
(g) claims directed to compact radial-table and low-overhead implementation embodiments.

Primary outputs of the disclosed method include gravitational potential, convergence, and shear. These outputs may be provided as fields, maps, grids, sampled values, or equivalent computational products.

As illustrated in FIG. 7, an output framework (700) may provide a potential output (702), a convergence output (704), a shear output (706), a magnification output (708), a mass-estimation output (710), and a provenance/report output (712). FIG. 7 thus links the core solving path to both primary outputs and subordinate downstream result forms.

Secondary outputs may include magnification, integrated or projected mass estimates, residual-comparison products, uncertainty annotations, validation summaries, and provenance or report information associated with the computation. Such outputs may be useful in scientific analysis, comparison against observations, or downstream computational workflows. Where magnification is desired, a representative implementation may compute:

mu=1/|(1−kappa)\hat{ }2−|gamma|\hat{ }2|

and may apply the resulting magnification to background source analysis, including flux-based or count-based analysis.

The present disclosure also supports a computer-readable-medium embodiment in which instructions, when executed by one or more processors, cause performance of the disclosed Sigma_b-adaptive kernel method. The disclosure further supports productized output embodiments, including generated gravitational potential maps, generated convergence maps, generated shear maps, and combinations thereof. Remote-compute or service implementations may also return such generated outputs. In one embodiment, the non-transitory computer-readable medium stores instructions for receiving prepared baryonic-density profiles, generating a radial table, executing accelerator-based solving, and returning gravitational and lensing-related outputs. In another embodiment, a remote-compute or cloud-service implementation accepts Sigma_b(R) profiles and mass grids through an interface, executes accelerator-based solving, and returns kappa, gamma1, and gamma2 maps with associated provenance information.

Although output and medium embodiments are worth preserving, they remain subordinate to the method and system identity of the invention. The patent should not be drafted as though the invention were primarily a reporting layer, an API, or an output-delivery service. The inventive center remains the multiplicative baryonic attenuation of the fixed base fractional kernel.

Optional embodiments include non-radial coverage maps such as C(x, y) or C(x, y, z), redshift-dependent coverage factors, multi-component attenuation factors, and additional baryonic input pathways beyond the preferred radial X-ray/SZ embodiments. These options are preserved to maintain support and future flexibility, but they are not necessary to practice the disclosed core invention. In one optional embodiment, a non-radial coverage map is used for a merging cluster with asymmetric gas distributions.

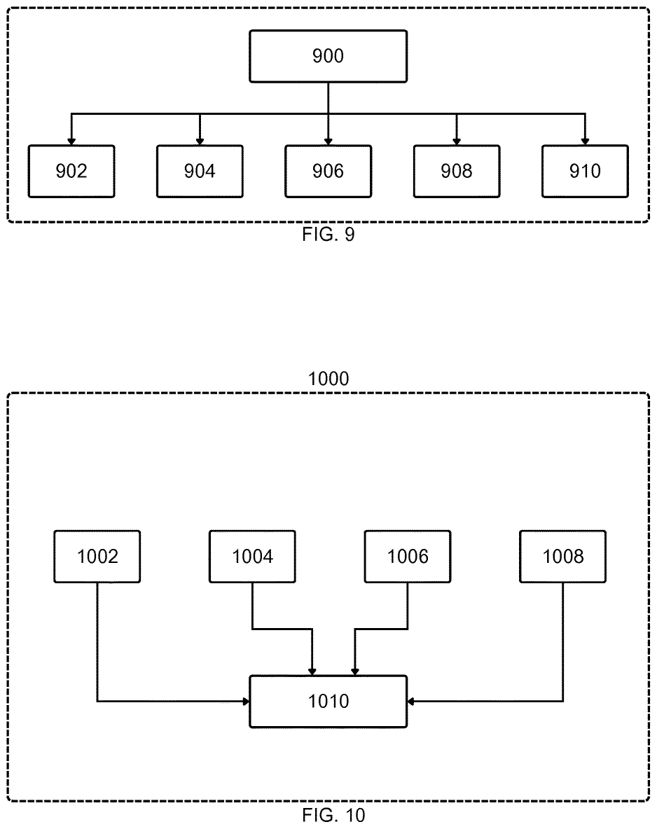

As illustrated in FIG. 9, an embodiment map (900) may include a non-radial coverage branch (902), a redshift branch (904), a multi-component branch (906), an alternate-input branch (908), and a continuation-target branch (910). FIG. 9 is intended to visually organize optional and alternative branches without allowing those branches to displace the disclosed core radial attenuation architecture.

Alternative embodiments may include alternate input-fusion logic, alternate interpolation methods, alternate compute hardware arrangements, and alternate data-file organizations. These alternatives are implementation-level variations that may be used so long as they preserve the disclosed core kernel architecture and do not convert the invention into a generic density-modulated gravity platform.

Prophetic embodiments may include survey-scale cosmological weak-lensing deployment, broad N-body substitution frameworks, large-scale cosmological parameter-estimation workflows, local infrastructure gravity-compensation systems, or other future-facing implementations. Such embodiments should be clearly presented as prophetic, continuation-oriented, or downstream support material rather than as central, reduced-to-practice embodiments of the core invention. In a local gravity-compensation or inertial-navigation embodiment, Sigma_b may represent the surface density of local terrain, infrastructure, or other dense environmental structure, and the disclosed coverage factor may provide additional gravity compensation beyond the base kernel.

The disclosure also preserves continuation-oriented claim targets including asymmetric-cluster-specific claim sets, tomography or redshift claim sets, multi-component attenuation claim sets, and broader non-astrophysical adaptation claim sets. These targets are useful for preserving future flexibility, but they remain outside the core identity of the present disclosure unless separately developed and supported. In a multi-component embodiment, separate attenuation factors may be assigned to gas, stars, and plasma, and each such attenuation factor may use an exponent of −7/12.

The foregoing optional, alternative, prophetic, and continuation-oriented material is not necessary to practice the core invention. The core invention remains the Sigma_b-driven multiplicative attenuation of a fixed fractional gravitational kernel for cluster-scale modeling without per-cluster halo fitting. Any future draft sections addressing examples, figures, claims, or downstream applications should preserve that identity and should not allow optional or future-facing branches to swallow the inventive center.

The following examples are provided to illustrate operation of the disclosed Sigma_b-adaptive kernel architecture. The examples are organized by support level. Demonstrated examples are presented as examples supported by the disclosure record. Downstream examples are presented as subordinate application-oriented uses of the disclosed method. Prophetic examples are presented to preserve support for future extensions and should not be read as reducing those embodiments to practice to the same extent as the disclosed core implementation and the demonstrated examples.

These examples are illustrative and do not redefine the inventive core. The inventive core remains the use of projected baryonic surface density to generate a multiplicative attenuation factor for a fixed fractional gravitational kernel without per-cluster halo fitting.

As illustrated in FIG. 8, a validation framework (800) may include a benchmark-cluster set (802), a residual-comparison block (804), an example workflow block (806), a runtime metric block (808), and a precision metric block (810). FIG. 8 provides a visual framework for organizing the demonstrated examples and validation-oriented material described below.

In a demonstrated validation configuration, the disclosed method is applied to a benchmark set of galaxy clusters and compared against both: (i) the unmodulated base kernel; and (ii) a conventional dark-matter halo fitting approach. In the disclosure record, the benchmark set includes clusters such as Abell 1689, CL 0024+17, MACS J0416, Bullet (1E 0657-56), and Coma.

In such a demonstrated comparison:
(a) the unmodulated base kernel produces systematic over-prediction of cluster weak-lensing shear;
(b) a fitted NFW or analogous dark-matter approach produces lower residuals at the cost of 3 to 5 free parameters per cluster; and
(c) the disclosed Sigma_b-adaptive kernel achieves materially improved cluster shear residuals relative to the unmodulated base kernel while preserving the no-per-cluster-halo-fit architecture.

By way of example from the disclosure record, the average benchmark residuals are reported as approximately 35.8% for the unmodulated base kernel, approximately 2.9% for fitted NFW dark-matter models, and approximately 5.1% for the disclosed RP+C(R) architecture. These values are presented as demonstrated validation support for the disclosed method and as evidence that the disclosed attenuation architecture materially reduces the cluster-scale over-response of the unmodulated kernel. The disclosure record further supports a narrower validation position in which weak-lensing shear residuals are less than approximately 8% for at least three galaxy clusters.

In one demonstrated example, the disclosed method is applied to Abell 1689 using a Chandra-derived X-ray Sigma_b profile. A representative implementation uses a radial Sigma_b profile spanning megaparsec-scale cluster radii, a computational grid for the solving pipeline, the fixed base kernel, and the disclosed coverage-factor law.

In the source disclosure, the coverage factor reaches a minimum value on the order of approximately 0.17 near the dense inner region of the cluster. The resulting solver output includes convergence and shear information. The disclosure record further reports that the disclosed method predicts a strong-lensing scale close to the observed value, with a representative observed Einstein-angle scale of approximately 47.0 arcseconds and a disclosed prediction of approximately 45.3 arcseconds, while the unmodulated base kernel yields an over-predicted value of approximately 64.5 arcseconds.

This example illustrates the practical make-and-use path of the disclosed invention:
(a) derive Sigma_b(R) from observed baryonic data;
(b) compute C(R);
(c) combine C(E) with K0(k);
(d) solve for gravitational potential and lensing quantities; and
(e) compare the result to observed cluster lensing behavior.

In another demonstrated example, the disclosed method is applied to the Bullet Cluster using combined X-ray and SZ baryonic information. The worked example is presented to illustrate how the disclosed attenuation architecture behaves when baryonic loading is spatially offset from other cluster components.

In the disclosure record, the baryonic coverage factor suppresses the kernel more strongly where the gas concentration is higher. The resulting convergence behavior is presented as shifting the lensing response away from the densest gas region and toward the collisionless galaxy component. A representative shear residual of approximately 5.1% is reported in the source disclosure. In claim-support terms, this worked example preserves a position in which the coverage factor shifts a lensing convergence peak away from a gas peak toward a galaxy component without a separate dark-matter halo.

This Bullet Cluster example should be treated as a worked example and validation-oriented illustration of the disclosed method. It should not be used to redefine the invention itself, and it should not be overstated as establishing broader formal closure of all cluster-lensing consequences in the Recognition framework source.

The disclosure record also preserves implementation-oriented demonstrated metrics. In one representative implementation:
(a) a radial coverage table is computed and stored for reuse during kernel application;
(b) the added coverage operation produces a small runtime increase relative to the base solver; and
(c) numerical precision comparisons indicate that implementation error may remain materially smaller than the observational uncertainty in the input Sigma_b profile.

By way of representative values preserved from the disclosure record, the coverage table may occupy approximately 2 kB in an FP32 implementation, and may be deployed in a GPU implementation such as an NVIDIA A100 environment or in an FPGA implementation such as a Xilinx VU9P environment. The added runtime overhead may be less than approximately 3%, and in one representative disclosure example is approximately 23 ms base plus approximately 0.6 ms coverage for a total of approximately 23.6 ms. The interpolation error may be less than approximately 10\hat{ }−5, and FP32 performance may remain within approximately 0.4% of an FP64 reference path, such that input baryonic uncertainty remains the dominant uncertainty source.

These implementation metrics are demonstrated engineering support and may support narrower claim positions, but they do not redefine the inventive core.

In a downstream example, the disclosed method is applied to a stacked cluster sample or survey-calibration workflow. In one such configuration, baryonic profiles from multiple clusters are processed in batch form and the resulting shear outputs are aggregated to form a mean profile or calibration dataset. In one preserved downstream configuration, the stacked sample may include at least 100 galaxy clusters and may be used to compute a mean shear profile for cosmological parameter estimation or survey calibration. The source disclosure further provides an illustrative stacked-SZ example involving approximately 1000 Planck clusters, approximately 128\hat{ }3 grid processing per cluster, and a disclosed result of less than approximately 6% RMS residual across the stack.

This example preserves support for survey-oriented and calibration-oriented use cases. However, it remains downstream and should not be elevated above the core cluster-kernel architecture unless further support warrants doing so.

In a prophetic embodiment, the radial coverage factor is generalized into a non-radial map such as C(x,y) or C(x,y,z), allowing the disclosed attenuation architecture to account more directly for asymmetric baryonic structure in merging or morphologically complex clusters.

This embodiment preserves support for asymmetric-cluster claim development, but it is not required to practice the disclosed core invention and should remain clearly identified as prophetic or continuation-oriented.

In another prophetic embodiment, the disclosed coverage factor is extended to include explicit redshift dependence, such as C(R,z), for use in tomography or time-evolving cluster modeling.

This embodiment preserves support for future redshift-aware claim sets while remaining outside the presently disclosed core implementation.

In another prophetic embodiment, separate attenuation factors are assigned to different baryonic subcomponents, such as gas, stars, and plasma, and are combined in a composite attenuation architecture. This preserves support for future multi-component claim development. It does not alter the fact that the presently disclosed core implementation is a fixed-form Sigma_b-driven multiplicative attenuation of a fixed base kernel.

In a further prophetic or downstream-support embodiment, the disclosed attenuation architecture is applied outside galaxy-cluster weak-lensing to local gravity-compensation or geodesy scenarios using dense-environment baryonic or mass-distribution maps. Such use is preserved to avoid unnecessary loss of future flexibility, but it is not part of the core inventive identity of the present specification.

What is claimed is:

1. A computer-implemented method for computing a gravitational potential or lensing-shear map at galaxy-cluster scale, the method comprising:
obtaining projected baryonic surface-density information for at least one region of a galaxy cluster;
generating a baryonic coverage factor from the projected baryonic surface-density information;
applying the baryonic coverage factor multiplicatively to a fixed fractional gravitational kernel to produce a modified kernel; and
applying the modified kernel to density information to obtain a gravitational potential Phi(r) or a lensing-shear map gamma(theta),
wherein no dark-matter halo parameters are fitted on a cluster-by-cluster basis.

2. A computer-implemented method for computing a gravitational potential or lensing-shear map at galaxy-cluster scale, the method comprising:
obtaining a baryonic surface-density profile Sigma_b(R) from X-ray, Sunyaev-Zel'dovich, or stellar-mass observations;
computing a coverage factor
C(R)=[1+Sigma_b(R)/Sigma_star]\hat{ }(−7/12),
where Sigma_star=90 g/cm\hat{ }2 and the exponent −7/12 is the negative of the Recognition-Physics loop ratio R_RP;
multiplying a fractional-Poisson kernel K0(k) of order 5/12 and softening k0=pi/phi by the coverage factor such that K(k,R)=C(R)*K0(k); and
convolving the modified kernel with a mass-density grid to obtain a gravitational potential Phi(r) or lensing-shear map gamma(theta),
wherein no dark-matter halo parameters are fitted on a cluster-by-cluster basis.

3. The method of claim 1, wherein the baryonic coverage factor is attenuation-only and does not amplify the fixed fractional gravitational kernel.

4. The method of claim 1, wherein the baryonic coverage factor satisfies 0<C(R)<=1 for nonnegative projected baryonic surface density.

5. The method of claim 1, wherein the baryonic coverage factor equals unity when projected baryonic surface density is zero.

6. The method of claim 1, wherein the baryonic coverage factor decreases with increasing projected baryonic surface density.

7. The method of claim 2, further comprising computing lensing convergence kappa and shear components gamma1 and gamma2 from the potential Phi via spectral second derivatives.

8. The method of claim 2, wherein Sigma_b(R) is derived from a combined X-ray and SZ observation providing both spatial and thermal information about the intra-cluster medium.

9. The method of claim 2, wherein the coverage factor C(R) is pre-computed as a one-dimensional radial lookup table.

10. The method of claim 9, wherein the one-dimensional radial lookup table is applied as a texture lookup inside an FFT-based solver.

11. The method of claim 9, wherein the one-dimensional radial lookup table is used in a radial FFT implementation in which indexing is based on:
R=2pi/|k|.

12. A computational system for cluster-scale gravitational modelling, comprising:
a baryonic input source configured to receive baryonic input information;
a profile-generation module configured to derive a baryonic surface-density profile from the baryonic input information;
a coverage-factor engine configured to compute a baryonic coverage factor from the baryonic surface-density profile;
a base-kernel engine configured to store, generate, or access a fixed fractional-Poisson kernel;
a kernel-combination engine configured to apply the baryonic coverage factor multiplicatively to the fixed fractional-Poisson kernel;
a solver engine configured to apply the modified kernel to density information to produce gravitational potential outputs and lensing maps; and
an output engine configured to provide the gravitational potential outputs and lensing maps, wherein the system operates without dark-matter halo parameters fitted on a cluster-by-cluster basis.

13. The system of claim 12, wherein the fixed fractional-Poisson kernel is K0(k)=1/(|k|\hat{ }2+k0\hat{ }2)\hat{ }(5/12) and k0=pi/phi.

14. The system of claim 12, wherein the coverage-factor engine computes C(R)=[1+Sigma_b(R)/Sigma_star]\hat{ }(−7/12).

15. The system of claim 12, wherein the output engine computes kappa, gamma1, and gamma2 spectrally from the modified potential.

16. A non-transitory computer-readable medium storing instructions that, when executed by a processor, cause performance of the method of claim 1.

17. The non-transitory computer-readable medium of claim 16, wherein the instructions are configured to accept FITS, HDF5, or CSV baryonic-density profiles and generate a radial table therefrom.

18. The system of claim 12, wherein the system is implemented on a GPU and a coverage table is stored as a one-dimensional texture.

19. The system of claim 12, wherein the system is implemented on an FPGA and a coverage table is stored in BRAM alongside a base-kernel memory structure.

20. A method for dark-matter-free cluster mass estimation, comprising:
obtaining Sigma_b(R) for a galaxy cluster;
computing lensing convergence kappa using the method of claim 2;
deriving projected mass M(<R) from kappa; and
reporting the mass without separate dark-matter and baryonic halo fitting.
